(19) United States
(12) Patent Application Publication
(10) Pub. No.: US 2010/0131111 A1
(43) Pub. Date: May 27, 2010

(54) Air Conditioner Water Pump Energy Saving Apparatus

(75) Inventor: Jen-Jui Cheng, Taipei (TW)

Correspondence Address: Eugene Lin, 976 Patrick Circle, Folsom, CA, 95630, US

(73) Assignees: Eugene Lin I; Christina Lin

(21) Appl. No.: 12/642,776

(22) Filed: Dec. 19, 2009

(30) Foreign Application Priority Data
Jul. 11, 2009 (TW) M361002

(51) Int. Cl. G05B 15/00

(52) U.S. Cl. 700/278

(57) ABSTRACT

An air-conditioner's electricity bill is often the biggest ticket item in commercial building's operating expense. Conventionally, the condensing unit, or the compressor, and the cooling water tower of a typical split air conditioner system are controlled independently. The cooling water pump for the cooling water tower is usually turned on with full power when the air conditioner is on, irrelevant of the season, the weather or the humidity. The apparatus of this invention frequency-controls the cooling water pump motor to regulate the pump motor load and to achieve the energy savings, based on the factors, such as the temperature difference between the cooling water and the return water, etc.

This apparatus of this invention includes a return-water temperature sensor, a cooling water temperature sensor, a CPU circuit board assembly, a compressor high pressure loop sensor, a compressor low pressure loop tensor, and a compressor status sensor.

### CROSS-REFERENCE TO FOREIGN PATENT CERTIFICATE

The entire content of this application document is based on the Patent Certificate Ser. No. M361002, issued in TAIWAN on Jul. 3, 2009. The inventor of the above said Taiwanese patent M361002 is hereby applying for a United States patent for the same invention.

### THE FIELD OF THE INVENTION

This invention is an add-on energy-saving apparatus to a common split air condition system with a or a plurality of cooling water towers. This apparatus achieves energy savings by optimizing the control of cooling water pumps.

### BACKGROUND OF THE INVENTION

An air-conditioner's electricity bill is often the biggest ticket item in commercial building's operating expense. Running the air conditioners smartly would save money for building owners, reduce the carbon foot-print, and help the United States to be more energy independent.

This invention relates to an HVAC add-on energy savings apparatus to any common split air-condition system. This apparatus achieves its energy-savings by optimizing the control of a or a plurality of cooling water pumps, based on the cooling water temperature difference and the compressor's pressure difference.

### PRIOR ART

Commercial or industrial grade split air conditioner system usually comes with an air blower, a water cooling tower, an evaporation unit and a condensing unit. Conventionally, a split air condition system's compressor and cooling water tower are controlled independently. A split air condition system's cooling water pump for the cooling water tower is usually turned on with full power when the air conditioner is on, irrelevant of the building occupancy, the season, the weather or the humidity.

### SUMMARY OF THE INVENTION

This invention's energy savings is achieved by frequency-changing the cooling water pump motor to reduce the pump motor load. The amount of the frequency-change is based the cooling water temperature difference and the compressor's pressure difference. This invention takes advantage of that the cooling water temperature difference and the compressor's pressure difference are the aggregate variation indication of the season, the weather, the humidity and the building occupancy etc., in which the air conditioner is operated.

This above said water temperature difference and the compressor pressure difference are measured at the steady state of an operated split air conditioner system with a or a plurality of water cooling towers.

### DETAIL DESCRIPTION

This apparatus of this invention includes a return-water temperature sensor, a cooling water temperature sensor, a CPU circuit board assembly, a compressor high pressure loop sensor, a compressor low pressure loop tensor, and a compressor status sensor.

The apparatus of claim 1 wherein the CPU circuit assembly board is connected to a plurality of sensor ports and a plurality of control ports.

The apparatus of claim 1 wherein the CPU's sensor ports are connected to water temperature sensors and compressor's pressure sensors

The apparatus of claim 1 wherein the CPU's control ports are connected to a or a plurality of motor controllers, or frequency converters.

The apparatus of claim 1 wherein the CPU controls a plurality of frequency converters based on the water temperature readouts and the compressor pressure readouts.

The apparatus of claim 1 wherein the CPU sets the frequency converter to low if the water temperature difference between the outgoing water and return water is low.

The apparatus of claim 1 wherein the CPU sets the frequency converter to high if the water temperature difference is high.

The apparatus of claim 1 wherein the CPU sets the frequency converter to full power if the compressor's pressure difference is high.

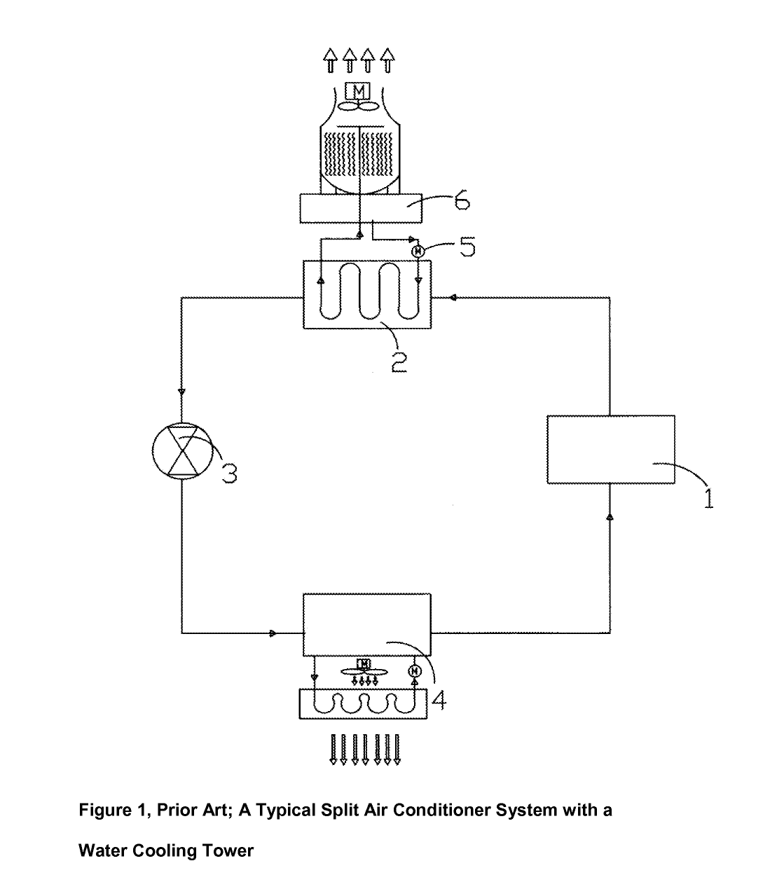

FIG. 1'S Item Description:
1. Compressor
2. Condenser
3. Expansion Valve
4. Evaporator
5. Cooling Water Pump
6. Cooling Water Tower

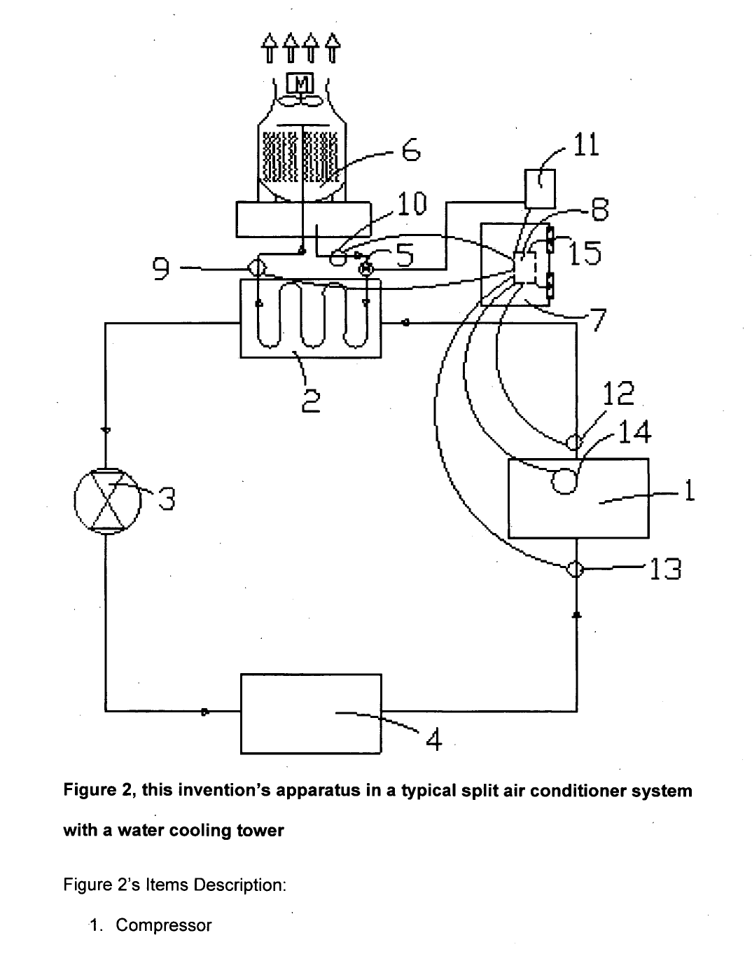

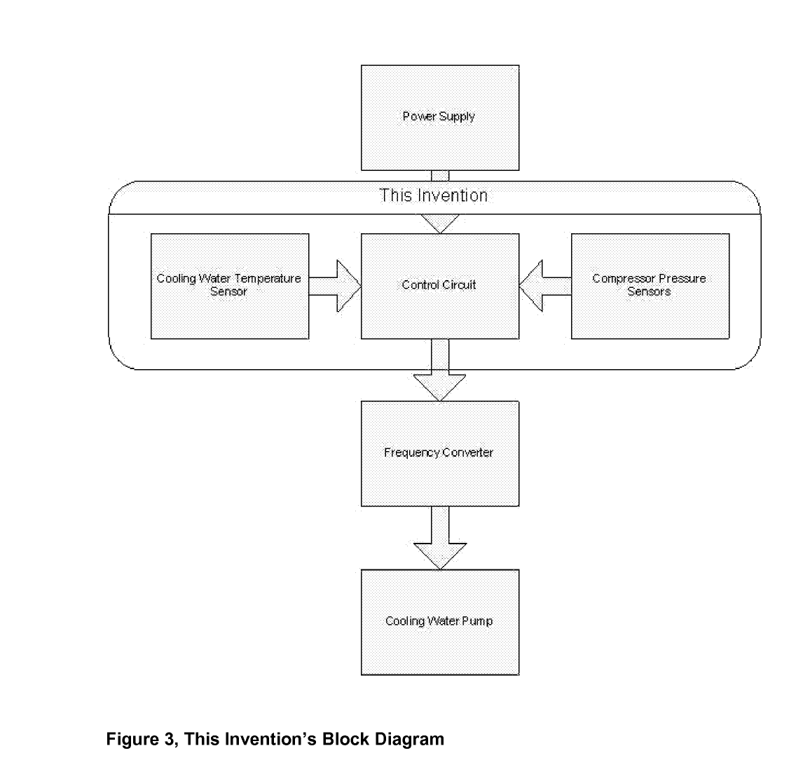

FIG. 2, This Invention's Apparatus in a Typical Split Air Conditioner System with a Water Cooling Tower

FIG. 2's Item Description:
1. Compressor
2. Condenser
3. Expansion Valve
4. Evaporator
5. Cooling Water Pump
6. Cooling Water Tower
7. Apparatus Housing (This invention from this item on)
8. Microcontroller Assembly
9. Cooling Water return temperature sensor
10. Cooling Water out-going temperature sensor
11. Frequency converter
12. Compressor High Pressure Loop Sensor
13. Compressor Low Pressure Loop Sensor
14. Compressor Operation Sensor
15. Cooling Fan

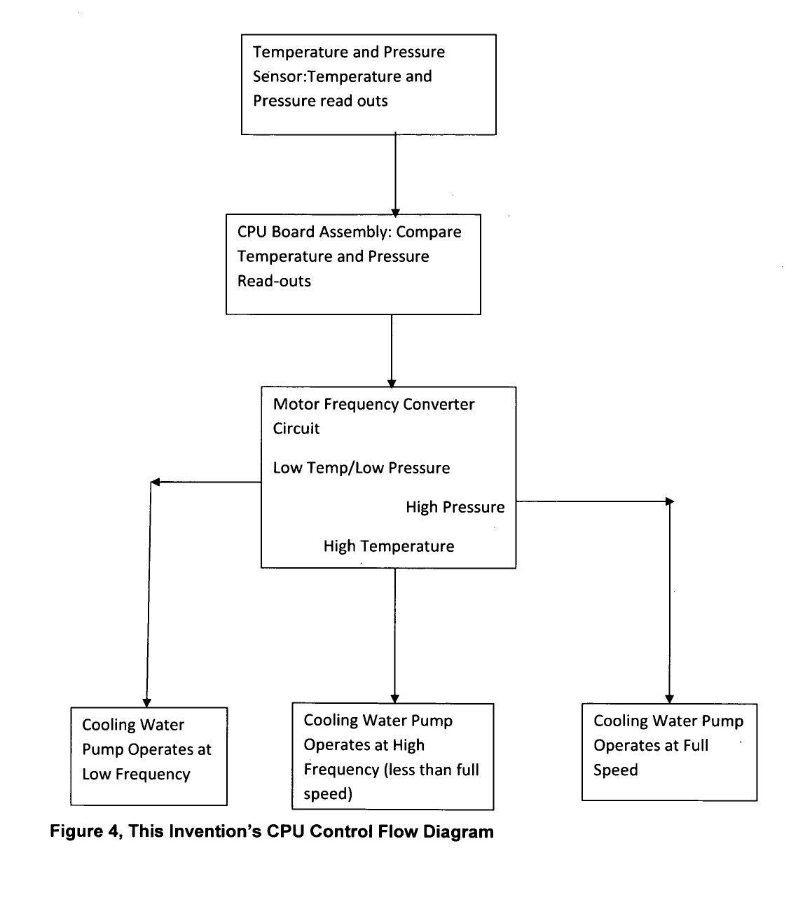

FIG. 4, This Invention's CPU Control Flow Diagram

1. The embodiment of a split air-conditioner energy saving apparatus is comprised of: a housing having a plurality of electrical signal control ports; a plurality of electrical signal sensing ports; a CPU printed circuit board assembly. This energy saving apparatus could be an add-on to any common split air condition system or be a feature of a newly manufactured air condition system. For an air conditioner with a or a plurality of water cooling towers, the said control apparatus regulates the water pump motor load, via a frequency converter based on the temperature difference between the outgoing cooling water and the return water, and the pressure difference between the compressor's high pressure loop and the low pressure loop to optimize the air conditioner operation. Hence the energy savings is achieved.

2. A method of regulating a common HVAC cooling water pump motor to achieve energy savings by measuring cooling water temperature difference, as an aggregate variation indicator of the season, the weather, the humidity and the building occupancy, etc.
